(19) United States
(12) Patent Application Publication
(10) Pub. No.: US 2014/0015279 A1
(43) Pub. Date: Jan. 16, 2014

(54) Truck Body For Mining Vehicle

(71) Applicants: Jose Rogerio De Paula e Silva, Nova Lima (BR); Alexandre Tavares, Bela Horizonte (BR)

(72) Inventors: Jose Rogerio De Paula e Silva, Nova Lima (BR); Alexandre Tavares, Bela Horizonte (BR)

(73) Assignee: ESCO CORPORATION, Portland, OR (US)

(21) Appl. No.: 13/937,872

(22) Filed: Jul. 9, 2013

Related U.S. Application Data
(60) Provisional application No. 61/669,809, filed on Jul. 10, 2012.

(51) Int. Cl. B62D 33/02

(52) U.S. Cl. CPC B62D 33/02
USPC 296/183.2

(57) ABSTRACT

A truck body for use with a mining dump truck uses a support structure having primary and secondary supports fixed to panels defining the hauling cavity. The use of primary and secondary supports in combination with thinner plate steel produces a stable, ultra-light truck body that enables a larger load of mined material to be transported in a single haul cycle. The provision of a larger hauled load results in a substantial increase in the efficiency of the mining operation and reduced costs.

### FIELD OF THE INVENTION

The present invention pertains to mining vehicles and particularly to truck bodies for off-road mining dump trucks.

### BACKGROUND OF THE INVENTION

Large mining dump trucks are used around the world to haul material excavated by a mining machine such as a dragline machine, cable shovel and the like. In surface mining, for example, these mining dump trucks repeatedly travel a prescribed course that involves receiving a load from the excavating machine, traveling to a location to dump the received load, and returning to the excavating machine for another load. Many trucks, one after the other, are commonly used to haul the material away in a continuous manner.

These mining vehicles are constructed to carry a maximum load which includes the weight of the truck body plus the weight of the mined material in the truck body. The standard truck body is fabricated of plate steel walls supported by a series of interconnected large, vertical and horizontal structural beams to carry the weight of the mined material and withstand the impacts associated with receiving the mined material from the excavating machine. Hardfacing is generally provided along the interior hauling surfaces of the truck body. These standard truck bodies are designed with a hauling capacity in a variety of sizes including a range of 64 m3 to 220 m3 and weigh, on account of the structural framework, heavy plate walls and hardfacing, on the order of 14 to 41.3 metric tons. The heavy weight of the truck body limits the load of mined material the truck can transport.

Light-weight truck bodies have been used in efforts to increase the mined material loads that can be transported. These light-weight truck bodies are constructed in generally the same manner as the standard heavier truck body, but with thinner plate material for the walls and smaller structural beams. The reduced weight of these truck bodies allows for more load to be carried in the truck body. However, the stability and durability of these light-weight truck bodies are substantially reduced. Accordingly, these light-weight truck bodies have shortened life spans running only about one third the life of the standard truck body, are subject to break-through holes caused by impacts from receiving the mined material (e.g., larger rocks), and result in unsteady loads such that the walls sway and cause mined material to spill out on the roadway during transport.

### SUMMARY OF THE INVENTION

The present invention pertains to a truck body for a mining dump truck that includes a framework of primary and secondary supports interconnected to support the plate steel walls of the hauling cavity. The secondary supports are substantially smaller in cross section than the primary supports. This use of primary and secondary supports enables the use of smaller supports and thinner plate as compared to standard truck bodies for an overall lighter weight without the loss of strength and stability found in previous light-weight truck bodies.

In one preferred embodiment of the invention, a truck body for receiving payloads includes a support structure comprising primary supports and secondary supports. The truck body is lighter than a conventional truck body and more stable than known light weight truck bodies to save costs, allow more material to be transported in each load, and provide a safer transport with reduced loss of material.

In another embodiment, the side of the truck body includes intersecting primary supports and smaller secondary supports to provide improved stability and a lighter body truck body having at least 150 cubic meter capacity and weighing no more than 30 metric tons, and preferably no more than 25 metric tons, without the application of hardfacing (i.e., before hardfacing is secured to the truck body).

In another aspect of the invention, a truck body includes walls defining a containment cavity for receiving mined material, a plurality of primary supports and a plurality of secondary supports smaller than the primary supports. With a containment cavity having a nominal payload of more than 136 metric tons, the truck body will weigh less than 11% of the nominal payload, and preferably less than 10%. With a containment cavity having a nominal payload of 136 metric tons or less, the truck body will weigh less than 15% of the nominal payload. Weight savings is achieved in all ranges of truck bodies for the large mining dump trucks, but a greater weight savings relative to the payload to be carried is achieved in the larger sizes.

In another aspect of the invention, a truck body comprises at least one generally horizontal primary support intersecting at least one generally vertical primary support, and intersecting secondary supports smaller than the primary supports and connected to the primary supports to define a grid for additional support with reduced weight.

In another aspect of the invention, a truck body for use with a mining dump truck comprises a floor with crossbeams, a front wall with vertical primary supports and sidewalls connected to the front wall and the floor. Each sidewall includes a top rail, one or more horizontal primary supports, one or more vertical primary supports intersecting the one or more horizontal primary supports and the top rail. The sidewalls also include intersecting vertical and horizontal secondary supports that are smaller than the primary supports.

In another aspect of the invention, a truck body for a mining dump truck comprises plate fixed together to form a floor, sidewalls, a front wall and a support structure connected to the plate. The support structure includes floor beams fixed to the floor in a longitudinal direction to facilitate attachment to a mining dump truck and crossbeams fixed to the floor extending transversely to the floor beams. The support structure also includes a top rail extending along a top of each said sidewall, a pair of generally vertical supports extending from an opposite end of one of the crossbeams to one of the top rails, a generally horizontal support extending between the top rails and the crossbeams and intersecting the vertical supports and a grid of horizontal and vertical partitions. Each of the grid components are fixed to each sidewall and to each of the supports.

### BRIEF DESCRIPTION OF THE DRAWINGS

FIG. 1 is a side view of a mining dump truck with a truck body in accordance with the present invention.

FIG. 2 is an upper perspective view of a truck body in accordance with the present invention.

FIG. 3 is a lower perspective view of the truck body.

FIG. 4 is a side view of the truck body.

FIG. 5 is a front view of the truck body.

FIG. 6 is a perspective view of the framework for the front wall of the truck body.

FIG. 7 is a top view of the truck body.

FIG. 8 is a bottom view of the truck body.

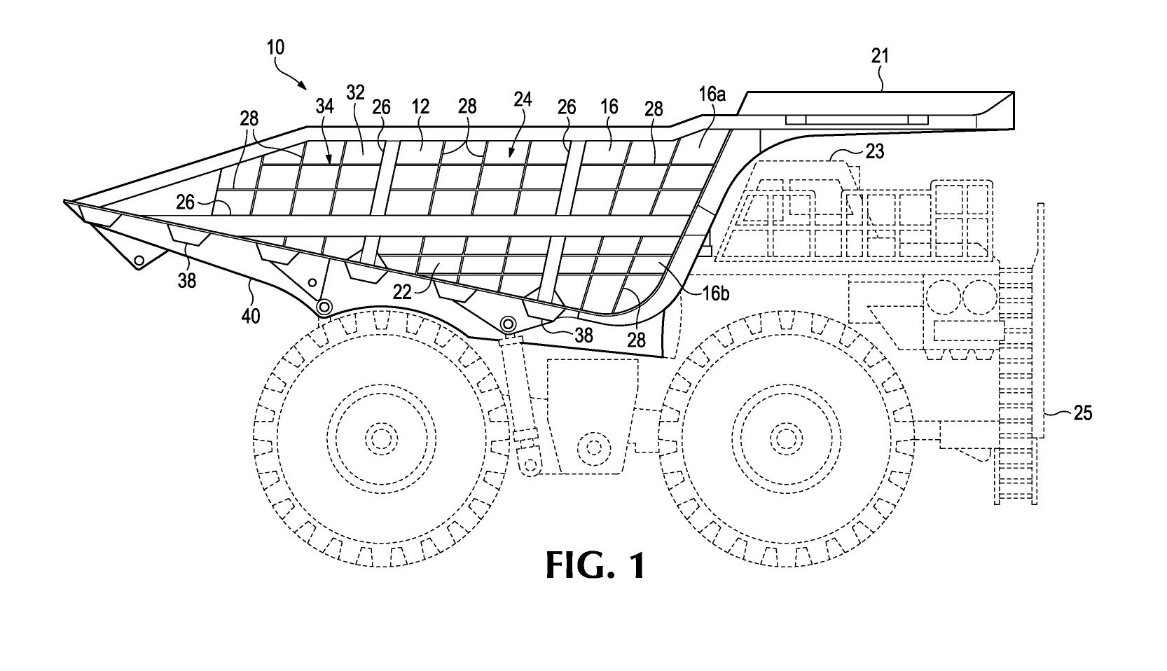

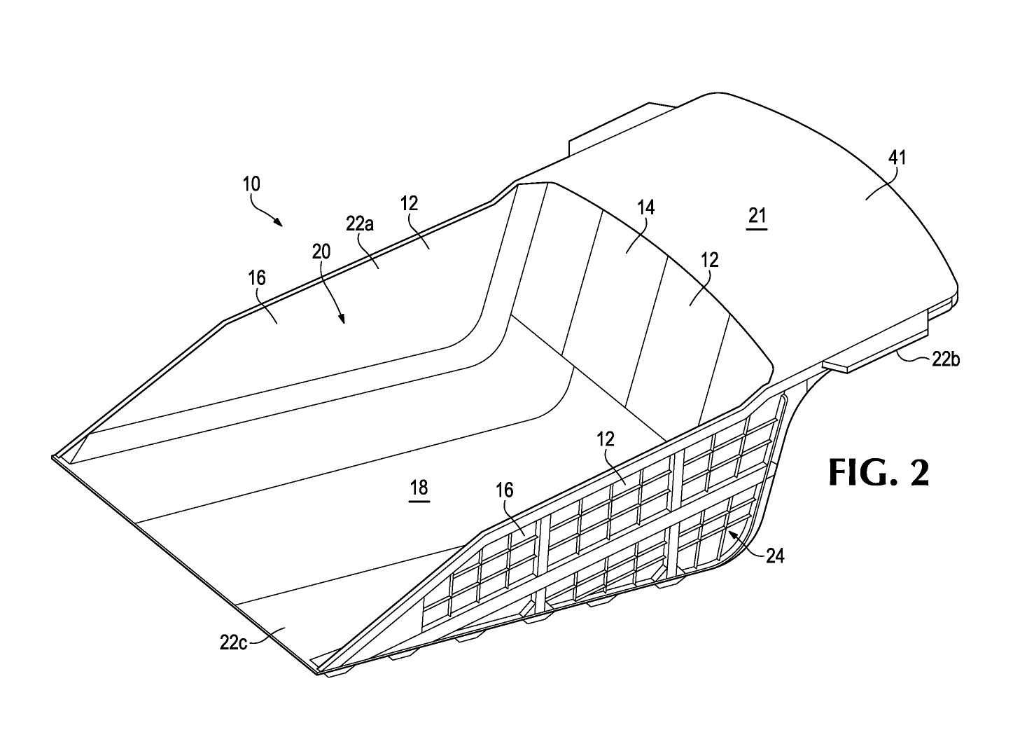

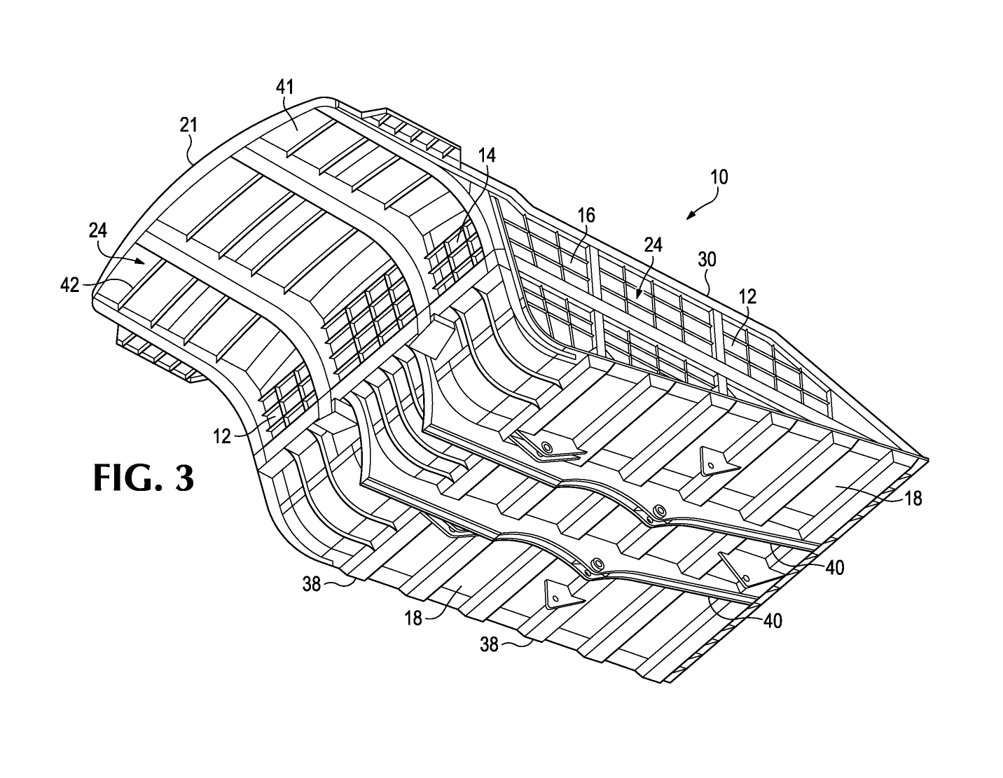

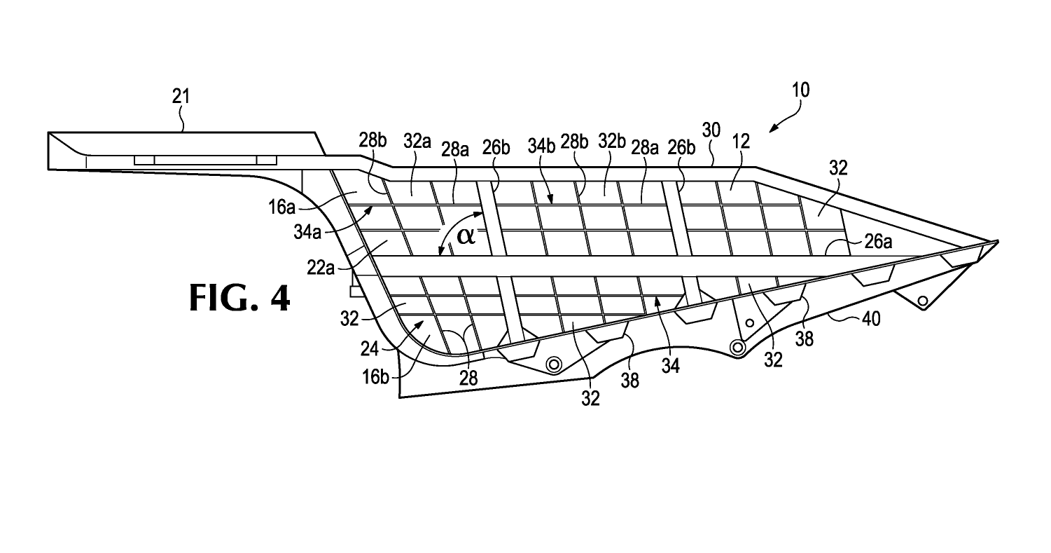

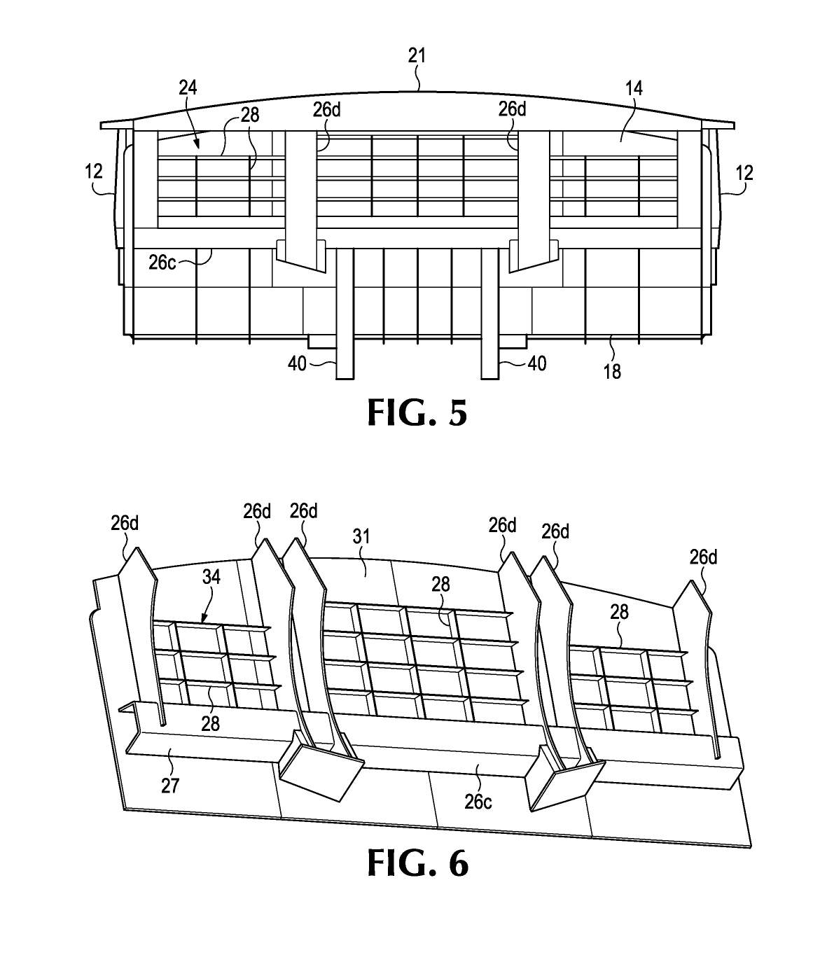

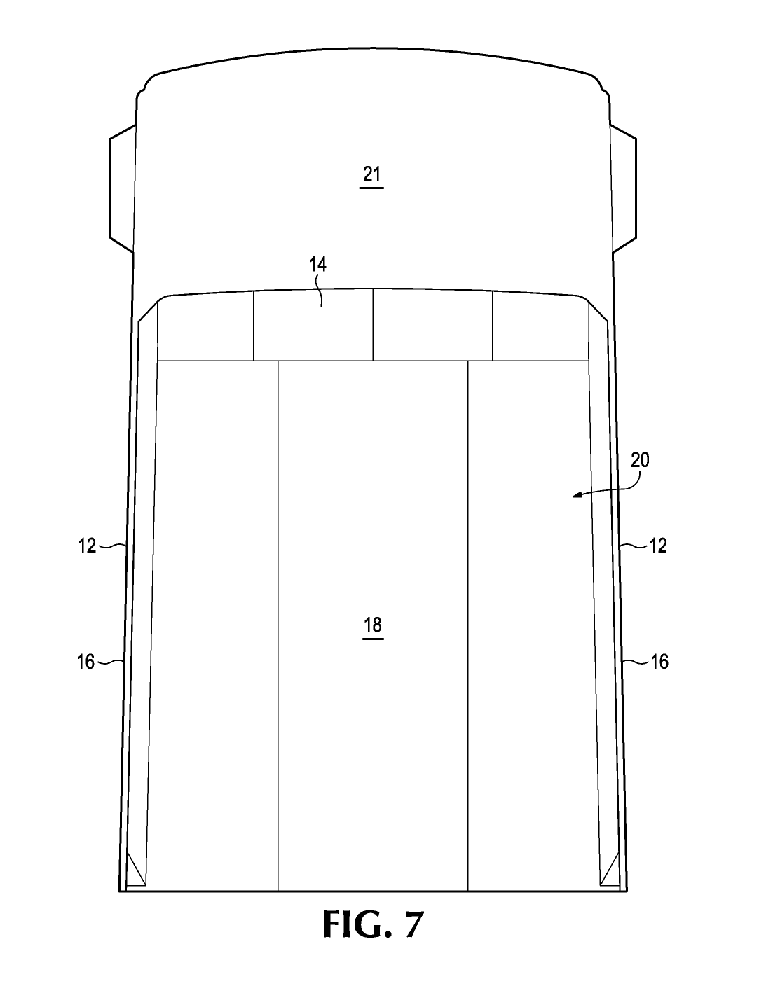

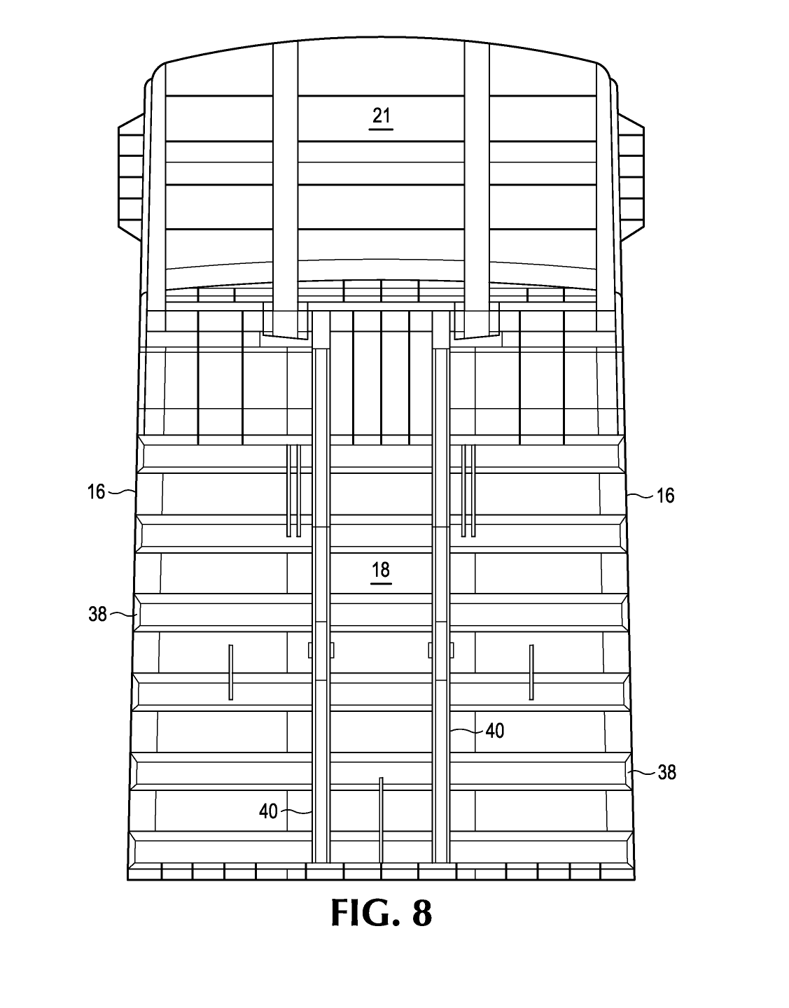

### DETAILED DESCRIPTION OF THE PREFERRED EMBODIMENTS

The present invention pertains to a truck body for use with a mining dump truck that enables a larger load of mined material to be transported in a single haul cycle. The provision of a larger hauled load results in a substantial increase in the efficiency of the mining operation and reduced costs. Mining trucks are off-road vehicles preferably with payload capacities greater than 90 metric tons, but smaller payload capacities are possible.

In accordance with one embodiment of the present invention, a truck body 10 is defined by a plurality of containment walls 12, including a front wall 14 and a pair of sidewalls 16, and a floor 18 that are joined together along edges to collectively define a hauling cavity 20 in which the mined material is received and carried. The truck body is pivotally mounted to a wheeled frame 25 that includes a cab 23 for the operator. A cover 21 extends forward over the cab 23 to protect it. Once the mined material is transported to its destination the truck body pivots on the wheeled frame to discharge the material from a rearward opening of the truck body.

Each containment wall 12 is preferably formed of a sheet of plate material 22 (either as a single sheet or multiple sheets welded or otherwise secured together), and a framework or support structure 24. Framework 24 is composed of primary supports 26 and secondary supports 28. The primary supports are substantially larger in cross section and mass than the secondary supports. Although framework 24 with primary supports 26 and secondary supports 28 is preferably provided on each containment wall 12, this framework could be provided on only one or more of the containment walls if desired.

In the illustrated example, each containment wall 12 includes a sheet of plate steel 22 to define the entire expanse of the wall. The walls of the ultra light truck body can have several thicknesses in order to enhance the weight savings and also keep the truck body stability (i.e., the front wall sheet steel is preferably thinner than the side walls sheet steel). Hardfacing (not shown) can be secured to the interior faces 12a, 18a of containment walls 12 (i.e., front wall 14 and sidewalls 16) and/or floor 18 to increase the wear life of truck body 10.

Each containment wall 12 also preferably includes a framework 24 welded to the plate steel sheet 22. The framework 24 comprises a plurality of large, preferably interconnected structural members referred to herein as the primary supports 26. Each containment wall 12 will include one or more first or generally horizontal primary supports 26a extending across a medial portion of the wall. A top rail 30 preferably extends along the top of each wall. The containment wall will also include one or more second or vertical primary supports 26b also extending across a medial portion of the wall. Although other arrangements of primary supports could be used, the primary supports preferably include those that are oriented primarily horizontally or primarily vertical. The framework 24 also includes a plurality of secondary supports 28, which are substantially smaller in cross section than the primary supports 26. In a preferred construction, the secondary supports 28 are interconnected with each other and with the primary supports to provide additional support and stability without adding much weight. The primary supports and the secondary supports are each preferable fixed (e.g., by welding) to the plate defining the wall.

In the illustrated embodiment, a first primary support 26a extends axially across plate 22a in generally a horizontal orientation, though other orientations are possible. A pair of second primary supports 26b is spaced along plate 22a in a generally vertical orientation. Although primary supports 26b are shown as being inclined forward as they extend from floor 18, they could have other orientations. Primary supports 26a, 26b are welded to plate 22a and to each other to form a primary framework 24a for supporting plate 22a and the load received into cavity 20. In a preferred embodiment primary supports 26a and 26b meet at an angle a of sixty degrees or more though the supports can meet at other angles. Top rail 30 extends along the top edge of each sidewall 16 and can act in a similar manner to the primary supports.

Secondary supports or partitions 28 are preferably arranged in a grid or lattice 34 in the openings or spaces 32 defined by framework 24 along plate 22. In this example, sidewall 16 includes six openings 32 of varying sizes and shapes—three above beam 26a and three below beam 26a. As an example only, first opening 32a includes two first or horizontal secondary supports 28a and two second or vertical secondary supports 28b welded together to form a first grid 34a. Grid 34a is also welded to plate 22a, primary supports 28a, 28b, and top rail 30. Second opening 32b includes two horizontal secondary supports 28a and three vertical secondary supports 28b welded together to define a second grid 34b. As with grid 34a, grid 34b is welded to plate 22a, primary supports 28a, 28b, and top rail 30. The other openings 32 are provided with similar grids 34. The vertical and horizontal secondary supports 28a, 28b can be continuous so as to extend through a plurality of openings 34 or be limited to span each opening 34. The secondary supports or grids provide enhanced support to containment walls 12 without adding much weight.

Front wall 14 is preferably formed with the same construction as sidewalls 16. That is, front wall includes a sheet of plate steel 22, primary supports 26, and secondary supports 28. In this example, a first primary support 26c extends horizontally across the bottom of front wall 14, and six spaced second primary supports 26d extend vertically between horizontal support 26c and the structure of cover 21 that extends forward over the cab of the truck. The cover 21 provides support for the top of the front wall. Secondary supports 28, preferably oriented in a grid 34, are welded to plate 22b, primary supports 26 and cover 21 in each opening 32 across front wall 14.

The primary supports can be defined as a folded member 27 of plate steel such as primary support 26c in FIG. 6. Spaced plate steel members 29 interconnected by crosspieces 31 can also be used to define a primary support such as in primary supports 26d in FIG. 6. The primary supports could also have other configurations such as structural members defined with rectangular box cross section tubular members. Plate 16 when welded to a folded member 27 forms one wall of a tubular primary support. Preferably, the primary supports are smaller than the supports used in standard truck bodies in order to maximize the weight savings in the truck body. Nevertheless, primary supports similar or the same as standard supports could be used. The use of such larger supports, though, would result in less weight savings, as the weight savings would then be confined to the use of thinner plate steel in the containment walls. The use of smaller primary supports 26 than are used in standard truck bodies substantially lessens the weight of truck body 10.

Secondary supports 28 are formed as plates, bars, rods, etc. that are welded to plate 22 and the primary supports 26 for enhanced support of the respective containment wall 12 and the mined material in cavity 20. In one example, as seen in FIG. 6, secondary supports are elongate strips of plate steel 33 oriented with a side edge against the plate steel sheet 22 defining front wall 14. The individual secondary supports 28 in this example have cross sectional dimensions of about ¼″×3″ for a rectangular cross section of 0.75 square inches. Primary supports are larger, with a substantially larger cross section, than the secondary supports. The cross-section of the primary supports can be considered to be the beam size of the support regardless of whether it is solid or tubular. For example, in a channel shaped support that is welded to a wall of the truck body, the beam will be the extension of the beam outward from the wall and the width of the portion extended from the wall. In one example, the cross section of the primary supports are 32 square inches.

Various alternatives for primary and secondary supports can be used so long as the primary supports are substantially larger in cross section than the secondary supports. The use of smaller secondary supports leads to a more light weight truck body when combined with thinner panels. Dimensions of the supports are dependent on the overall size and capacity of the truck body and other sizes of primary and secondary supports can be used. Supports can be solid or tubular and can be of any cross-sectional shape. Preferably the secondary supports are at least 50% less than the cross-section of each of the primary supports.

In the illustrated example, floor 18 is formed with a conventional construction to facilitate connection and use with one model of a standard mining dump truck. Floor 18 is formed of a plate steel sheet 22c, crossbeams 38, and axial mounting beams 40. Other floor constructions could be used to match other styles of mining dump trucks, and thereby facilitate connection of truck body 10 to any mining dump truck.

A top rail 30 preferably extends along the top edge of the sheet plate 22 defining each sidewall 16. Cover 21 extends across the top edge of the sheet plate 22 defining the front wall 14. The top rail 30 and cover 21 assist in protecting the truck body from wear as the load is dumped into cavity 20, and to further enhance the strength and stability of the truck body 10. Cover 21 is defined by plate steel sheets 41 and crisscross structural members 42. Cover 21 protects the cab 23, but also is used to enhance the overall support of the truck body 10.

The use of thinner plate steel, smaller primary supports and secondary supports results in a truck body which is substantially lighter than the standard truck bodies. As noted above, a standard truck body with interior hardfacing attached has a hauling capacity of about 150 m³ and weighs about 35 tons. A truck body constructed in accordance with the present invention has a capacity, in this example of about 150 m³ and weighs less than 30 metric tons without the application of hardfacing, and preferably less than 25 metric tons. In the illustrated example, a truck body having a volume capacity of 160 m³ and a nominal payload of 227 metric tons weighs about 24 metric tons without hardfacing. This additional weight savings enables the capacity of truck body 10 to be about 160 m³, which is an increase of about 10 m³ over the standard truck body. This additional weight savings enables the capacity of truck body 10 to be about 160 m³, which is an increase of about 10 m³ over the standard truck body.

In general, the number of tons that are taken out of the weight of the truck body can mean the same number of increased tons that can be hauled by the truck provided the truck body can safely and securely carry the load. Accordingly, if the truck body weighs 11 tons less, 11 tons more of the mined material can be carried without overloading the truck. While an ultra light weight truck body is intended to maximize payload over maximizing usable life, interior hardfacing can be used in truck body 10. With hardfacing, the illustrated truck body weighs about 30-31 metric tons, which still results in higher capacities over the standard truck body.

TABLE 1

| | |
|---|---|
| Nominal | Body Weight |
| Payload | (Metric tons) |

| Metric | Conventional | Inventive | Weight |
|---|---|---|---|
| tons | Structure | Structure | Reduction |
| 91 | 16 | 11 | 25% |
| 136 | 25 | 19 | 23% |
| 177 | 21 | 16 | 22% |
| 227 | 30 | 24 | 20% |
| 313 | 35 | 30 | 15% |
| 363 | 41 | 36 | 13% |

Table 1 illustrates weight savings that can be achieved using the inventive support structure to construct a truck body. The table shows the weight of a truck body using a conventional structure and the weight of a truck body using the inventive support structure for a range of nominal payloads. The nominal or rated payload is determined by the manufacturer and is based on the size of the truck frame, engine power, brake size and other factors. For a nominal truck payload of more than 136 metric tons, a truck body utilizing the inventive support structure can weigh less than 11% of the nominal payload of the dump truck and preferably less than 10% of the nominal payload. For a nominal truck payload of less than or equal to 136 metric tons, a truck body utilizing the inventive support structure can weigh less than 15% of the nominal payload of the dump truck. All weight values listed are without hardfacing on the truck body.

That is, a greater weight savings in the sense of the mass of the truck body for the amount of payload that can be carried can be obtained with the larger truck bodies in the dump trucks larger than 136 metric tons nominal payload. in these larger trucks, the truck body in accordance with the present invention will weigh no more than about 11 percent of the nominal payload, and preferably less than 10 percent. In small trucks (i.e., with a nominal payload of 136 metric tons or less), the truck body in accordance with the present invention will weigh no more than about 15 percent of the nominal payload.

The use of a lower weight truck body can result in a substantial savings at a mine, particularly for large mining operations. In view of the increased payload available by use of the truck bodies in accordance with the present invention, a mine may be able to reduce the number of trucks needed from, e.g., 100 to 95. The reduction of even a single truck is a tremendous savings as these vehicles can cost on the order of USD3.5 million. The operational costs associated with a single truck over the course of a year are also substantial, and the elimination of even one truck would be valuable savings for the mine. As an example only, when considering the cost of the trucks, their operational costs and the increased production of using truck bodies in accordance with the invention, a mine may save up to USD15 million per year or more.

The lower weight and greater hauled loads are accomplished in truck body 10 without the concomitant instability that exists in the current offerings of light-weight truck bodies. The use of secondary supports across front wall 14 and sidewalls 16 provide enough additional support along containment walls 12 to substantially offset the loss of stability that exists through the use of thinner plate steel and smaller primary supports.

While secondary supports 28 are in the illustrated example shown in a rectangular grid, other arrangements could be used. As examples only, secondary supports could be provided only vertically or only horizontally, they could be oriented on diagonal grids (i.e., with secondary supports inclined 45 degrees or other angles), or consist of a grid defined by one of concentric circles, hexagonal honeycomb and radial members. Virtually any configuration of secondary supports could be used so long as the arrangement provides enough support to the containment walls. Further, secondary supports could be used on just one or some of the containment walls, or on the floor as well as the containment walls.

Spacing between secondary supports 28 can vary over different areas of the support structure 24. The upper portion 16a of the truck body tends to be subject to lower loading and stress than the floor and lower portions 16b of the walls which tends to be subject to higher loading. The support structure can be optimized by enhancing the support structure at the lower areas while using a lighter structure in upper sections. Increasing spacing of the grid in the upper sections decreases structure weight. Decreasing spacing in the lower section increases strength to resist heavy loads. Locally optimizing the grid and support structure lowers the overall weight of the support structure.

It should be appreciated that although selected embodiments of the representative truck body and payload carrier are disclosed herein, numerous variations of these embodiments may be envisioned by one of ordinary skill that do not deviate from the scope of the present disclosure.

The disclosure set forth herein encompasses multiple distinct inventions with independent utility. The various features of the invention described above are preferably included in each truck body. Nevertheless, the features can be used individually in a truck body to obtain some benefits of the invention. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

1. A truck body for use with a mining dump truck comprising a floor with crossbeams, a front wall with vertical primary supports, and sidewalls connected to the front wall and the floor, each sidewall including one or more generally horizontal primary supports, one or more generally vertical primary supports intersecting the one or more generally horizontal primary supports, and intersecting secondary supports connected to the primary supports, the secondary supports being substantially smaller in cross section than the primary supports.

2. The truck body of claim 1 wherein the secondary supports include generally vertical secondary supports and generally horizontal secondary supports.

3. The truck body of claim 1 including a top rail on each sidewall, where each said generally vertical primary support on each said sidewall extends between a floor crossbeam and the top rail.

4. The truck body of claim 1 wherein the secondary supports span spaces along the sidewalls defined at least in part by the primary supports.

5. The truck body of claim 1 wherein the secondary supports are flat plates and the primary supports are tubular beams.

6. The truck body of claim 1 wherein the payload capacity of the truck body is greater than 90 metric tons.

7. The truck body of claim 1 wherein the front wall includes horizontal and vertical secondary supports connected to the primary vertical supports.

8. The truck body of claim 1 wherein the cross-section of each of the secondary supports is at least 50% less than the cross-section of each of the primary supports.

9. The truck body of claim 1 wherein the primary supports and the secondary supports collectively define a support structure that is connected to steel sheet that defines the sidewalls of the truck body.

10. The truck body of claim 1 wherein a nominal payload rating of the dump truck is more than 136 metric tons and the weight of the truck body without hardfacing is less than eleven percent of the nominal payload.

11. The truck body of claim 1 wherein a nominal payload rating of the dump truck is more than 136 metric tons and the weight of the truck body without hardfacing is less than ten percent of the nominal payload.

12. The truck body of claim 1 wherein a nominal payload rating of the dump truck is less than or equal to 136 metric tons and the weight of the truck body without hardfacing is less than fifteen percent of the nominal payload.

13. The truck body of claim 1 wherein the secondary supports have increased spacing in upper portions of the wall panel as compared to their spacing in lower portions of the sidewall.

14. A truck body for a mining dump truck comprising:
plate fixed together to form a floor, sidewalls and a front wall; and
a support structure connected to the plate and including:
floor beams fixed to the floor in a longitudinal direction to facilitate attachment to a mining dump truck;
crossbeams fixed to the floor, the crossbeams having opposite ends and being connected to and extending transversely to the floor beams;
a top rail extending along a top of each said sidewall;
a pair of generally vertical supports fixed to each said sidewall, each said generally vertical support extending from an opposite end of one of the crossbeams to one of the top rails;
a generally horizontal support fixed to each said sidewall and extending between the top rails and the crossbeams, and intersecting the vertical supports; and
a grid of horizontal and vertical partitions fixed to each sidewall and each of the supports.

15. The truck body of claim 14 wherein the truck nominal payload is less than or equal to 136 metric tons and the weight of the truck body without hardfacing is less than fifteen percent of the truck nominal payload.

16. The truck body of claim 14 wherein the truck nominal payload is greater than 136 metric tons and the weight of the truck body without hardfacing is less than eleven percent of the truck nominal payload.

17. The truck body of claim 14 wherein the truck nominal payload is greater than 136 metric tons and the weight of the truck body without hardfacing is less than ten percent of the truck nominal payload.

18. The truck body of claim 14 wherein a plurality of the supports and a plurality of the partitions are fixed to the front wall.

19. A truck body for a mining dump truck comprising panels defining a floor, a front wall and sidewalls, and primary supports and secondary supports connected to and extending along at least each of the sidewalls, the secondary supports being substantially smaller in cross-section than the primary supports, the panels collectively defining a load capacity of at least 150 cubic meters and the truck body weighing no more than 30 metric tons without the addition of hardfacing.

20. The truck body of claim 15 wherein the primary supports on each said sidewall intersect each other, and the secondary supports on each sidewall intersect each other.

21. The truck body of claim 15 wherein the secondary supports define a grid on each said sidewall and are connected to the primary supports on the same sidewall.

22. The truck body of claim 15 wherein the truck body weighs no more than 25 metric tons without the addition of hardfacing.

23. The truck body of claim 15 wherein the cross-sectional area of each of the secondary supports is at least 50% less than the cross-section of each of the primary supports.

24. A truck body for a mining dump truck comprising a front wall, sidewalls and a floor collectively defining a containment cavity for receiving mining material, a plurality of primary supports fixed to and extending along each of the sidewalls, and a plurality of secondary supports fixed to and extending along each of the sidewalls, the secondary supports intersecting the primary supports on the same sidewall and being substantially smaller in cross section than the primary supports.

25. A truck body in accordance with claim 24 wherein the nominal payload for the containment cavity is more than 136 metric tons, and the weight of the truck body is less than eleven percent of the nominal payload.

26. A truck body in accordance with claim 24 wherein the nominal payload for the containment cavity is more than 136 metric tons, and the weight of the truck body is less than ten percent of the nominal payload.

27. A truck body in accordance with claim 24 wherein the nominal payload for the containment cavity is no more than 136 metric tons and the weight of the truck body is less than fifteen percent of the nominal payload.

28. A truck body in accordance with claim 24 wherein the primary supports on each sidewall are intersecting of each other, and the secondary supports on each sidewall are intersecting of each other.
